(19) United States
(12) Patent Application Publication
(10) Pub. No.: US 2026/0035192 A1
(43) Pub. Date: Feb. 5, 2026

(54) PAPER FEEDING ROLL

(71) Applicant: Sumitomo Riko Company Limited, Aichi (JP)

(72) Inventors: Shimpei Miyagawa, Aichi (JP); Daiki Ito, Aichi (JP)

(73) Assignee: Sumitomo Riko Company Limited, Aichi (JP)

(21) Appl. No.: 19/353,582

(22) Filed: Oct. 8, 2025

Related U.S. Application Data
(63) Continuation of application No. PCT/JP2024/020672, filed on Jun. 6, 2024.

(30) Foreign Application Priority Data
Jun. 29, 2023 (JP) 2023-106601

(51) Int. Cl. B65H 3/06; B65H 5/06

(52) U.S. Cl. CPC B65H 3/06; B65H 5/06

(57) ABSTRACT

A paper delivery roll (12) includes: a shaft body (12a) and an elastic body layer (12b) formed on an outer peripheral surface of the shaft body (12a). A convex part (13) having a forward inclined surface (13a) whose inclination increases along a paper passing direction (Y) is provided on the outer peripheral surface of the elastic body layer (12b). An angle (θ1) of the forward inclined surface (13a) is 25° or more and 55° or less. A ratio of a nip area to a product of a nip width and a roll surface length at a load of 500 g is 0.2 or more and 0.6 or less.

### CROSS-REFERENCE TO RELATED APPLICATION

This application is a continuation of PCT International Application No. PCT/JP2024/020672, filed on Jun. 6, 2024, which claims priority under 35 U.S.C § 119(a) to Japanese Patent Application No. 2023-106601, filed on Jun. 29, 2023. Each of the above application(s) is hereby expressly incorporated by reference, in its entirety, into the present application.

### TECHNICAL FIELD

The disclosure relates to a paper feeding roll that is suitably used in an electrophotographic device such as a copier, a printer, a facsimile machine, etc., which adopts an electrophotographic method.

### RELATED ART

Electrophotographic devices such as copiers, printers, facsimile machines, etc., that adopt the electrophotographic method include a paper feeding device. The paper feeding device includes a drawing roll (pickup roll) that feeds out paper from a paper feeding cassette, a paper delivery roll (feed roll) and a separation roll (retard roll) that transport the fed paper.

### PRIOR ART DOCUMENT(S)

### Patent Document(s)

Patent Document 1: Japanese Patent Application Laid-open No. 2000-281223
Patent Document 2: Japanese Patent Application Laid-open No. 2022-164161

Such paper feeding roll maintains the friction with paper by using the tackiness derived from rubber, and transports the paper. The paper feeding roll needs to maintain the paper transport function throughout the required service life. However, paper powder, represented by calcium carbonate, falls off from the transported paper each time and adheres to the roll surface. When the paper powder adheres to the roll surface, the contact between the rubber and the paper is affected, and the transport function deteriorates. As a result, a paper jam occurs.

In Patent Document 1, protruding strips are provided on the outer peripheral surface of a cylindrical rotating body in a direction parallel to the rotation axis, and, by making the shape of the peaks of the protruding strips more acute than conventional ones, the grip on the paper is improved, and paper feeding is stably and reliably. Also, in Patent Document 2, the convex strips of the feed roll extend in the axial direction, and the convex strips of the retard roll extend in the peripheral direction. Accordingly, fine powder, such as paper powder, escape into groove parts between the convex strips of the feed roll and groove parts between the convex strips of the retard roll. As a result, the accumulation of paper powder in the nip part between the convex strips of the feed roll and the convex strips of the retard roll is suppressed.

However, until now, attention has not been placed on how smoothly paper powder adhering to the roll surface can be removed, and there is still room for improvement in suppressing paper jams caused by paper powder.

The disclosure provides a paper feeding roll that can secure durability by suppressing wear on the roll surface while removing paper powder adhering to the roll surface to suppress paper jams.

### SUMMARY

A paper feeding roll according to an embodiment of the disclosure includes: a shaft body; and an elastic body layer, formed on an outer peripheral surface of the shaft body. A convex part having a forward inclined surface whose inclination increases along a paper passing direction is provided on the outer peripheral surface of the elastic body layer. An angle of the forward inclined surface is 25° or more and 55° or less. A ratio of a nip area to a product of a nip width and a roll surface length at a load of 500 g is 0.2 or more and 0.6 or less.

### BRIEF DESCRIPTION OF THE DRAWINGS

FIG. 1 is a schematic view of a paper feeding device.

FIGS. 2A and 2B are views of a paper delivery operation of the paper feeding device shown in FIG. 1. FIG. 2A shows a state before a single sheet of paper arrives between the rolls, and FIG. 2B shows an operation when a single sheet of paper arrives between the rolls.

FIGS. 3A and 3B are views of a paper delivery operation of the paper feeding device shown in FIG. 1. FIG. 3A shows a state before two sheets of paper arrive between the rolls, and FIG. 3B shows an operation when two sheets of paper arrive between the rolls.

FIG. 4 is a schematic view of the appearance of a paper feeding roll according to an embodiment of the disclosure.

FIG. 5 is a schematic view illustrating the shape of a convex part.

FIGS. 6A and 6B are schematic views illustrating another embodiment of the convex part.

### DESCRIPTION OF THE EMBODIMENTS

A paper feeding roll according to an embodiment of the disclosure includes: a shaft body; and an elastic body layer, formed on an outer peripheral surface of the shaft body. A convex part having a forward inclined surface whose inclination increases along a paper passing direction is provided on the outer peripheral surface of the elastic body layer. An angle of the forward inclined surface is 25° or more and 55° or less. A ratio of a nip area to a product of a nip width and a roll surface length at a load of 500 g is 0.2 or more and 0.6 or less.

A top surface whose angle is smaller than the forward inclined surface of the convex part may be provided at a top of the convex part. At this time, a ratio of a peripheral length of the top surface to a peripheral length of a bottom surface of the convex part may be 0.05 or more and 0.3 or less. In addition, the convex part may have a reverse inclined surface whose inclination increases along a direction opposite to the paper passing direction. At this time, an angle of the reverse inclined surface may be configured to be greater than the angle of the forward inclined surface. In addition, the angle of the reverse inclined surface may be 60° or more and 90° or less. In addition, a height of the convex part may be 40 μm or more and 200 μm or less. In addition, a JIS-A hardness of a surface of the elastic body layer may be 35° or more and 75° or less.

(1) A paper feeding roll according to an embodiment of the disclosure includes: a shaft body; and an elastic body layer, formed on an outer peripheral surface of the shaft body. A convex part having a forward inclined surface whose inclination increases along a paper passing direction is provided on the outer peripheral surface of the elastic body layer. An angle of the forward inclined surface is 25° or more and 55° or less. A ratio of a nip area to a product of a nip width and a roll surface length at a load of 500 g is 0.2 or more and 0.6 or less.

(2) In (1) above, a top surface whose angle is smaller than the forward inclined surface of the convex part may be provided at a top of the convex part.

(3) In (2) above, a ratio of a peripheral length of the top surface to a peripheral length of a bottom surface of the convex part may be 0.05 or more and 0.3 or less.

(4) In any one of (1) to (3) above, the convex part may have a reverse inclined surface whose inclination increases along a direction opposite to the paper passing direction, and an angle of the reverse inclined surface may be configured to be greater than the angle of the forward inclined surface.

(5) In (4) above, the angle of the reverse inclined surface may be 60° or more and 90° or less.

(6) In any one of (1) to (5) above, a height of the convex part may be 40 μm or more and 200 μm or less.

(7) In any one of (1) to (6) above, a JIS-A hardness of a surface of the elastic body layer may be 35° or more and 75° or less.

According to the paper feeding roll according to the disclosure, by including the convex part having the forward inclined surface whose inclination increases along the paper passing direction on the surface of the elastic body layer, the spot for releasing paper powder can be formed. By setting the angle of the forward inclined surface to 25° or more, a strong shear force is applied to the convex part and paper powder, and paper powder can discharged to the spot. Also, by setting the ratio of the nip area to the product of the nip width and the roll surface length to 0.6 or less at the load of 500 g, a strong shear force is applied to the convex part and paper powder, and the paper powder can be discharged to the spot. This makes it possible to remove paper powder adhering to the roll surface and suppress paper jams due to a reduced friction force. By setting the angle of the forward inclined surface to 55° or less, shear force is not excessively applied to the convex part, and the decrease in friction coefficient due to wear is suppressed. In addition, by setting the ratio of the nip area to 0.2 or more, shear force is not excessively applied to the convex part, and the decrease in friction coefficient due to wear is suppressed. Accordingly, it is possible to suppress paper jams.

By having the top surface 13c with an angle smaller than the forward inclined surface of the convex part at the top of the convex part, the wear at the top of the convex part is suppressed, and the deterioration of durability is suppressed. At this time, when the ratio of the peripheral length of the top surface to the peripheral length of the bottom surface of the convex part is 0.05 or more, wear at the top of the convex part is more easily suppressed. In addition, when the ratio is 0.3 or less, paper powder is less likely to accumulate at the top of the convex part, and paper powder is discharged to the spot easily.

In addition, the convex part may have a reverse inclined surface whose inclination increases along a direction opposite to the paper passing direction. At this time, by configuring the angle of the reverse inclined surface to be larger than the angle of the forward inclined surface, paper powder is less likely to accumulate at the top of the convex part, making it easier to discharge paper powder to the spot. In addition, when the angle of the reverse inclined surface is 60° or more, the angle of the reverse inclined surface is not excessively gentle, so paper powder is easily discharged to the spot. When the angle of the reverse inclined surface is 90° or less, the strength of the convex part is secured. Therefore, it is possible to easily apply a shear force to the convex part and paper powder, thus making it easier to discharge paper powder to the spot.

When the height of the convex part is 40 μm or more, the reduction in durability due to wear is easily suppressed. Also, a shear force is more easily applied to paper powder, making it easier to discharge paper powder to the spot. And when the height of the convex part is 200 μm or less, the strength of the convex part 13 is secured, making it easier for the shear force to be applied to the convex part and easier for shear force to be applied to paper powder to easily discharge the paper powder to the spot. Also, shear force is not excessively applied to the convex part, and the reduction in durability due to wear is suppressed.

When the JIS-A hardness of the surface of the clastic body layer may be 35° or more and 75° or less, the reduction in durability due to wear is easily suppressed. Moreover, when the JIS-A hardness of the surface of the clastic body layer is 75° or less, the shear force is not excessively applied to the convex part, and the reduction in durability due to wear is suppressed.

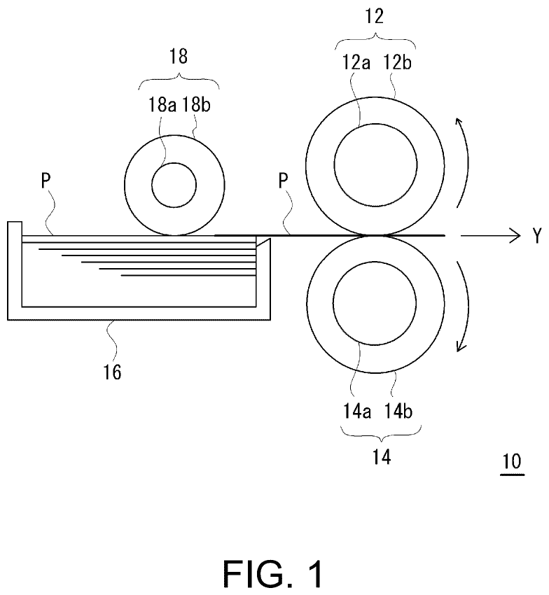

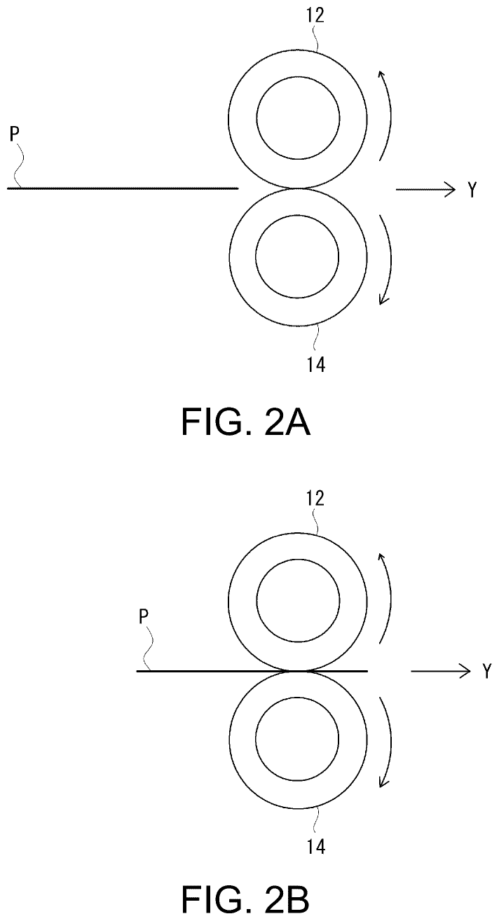

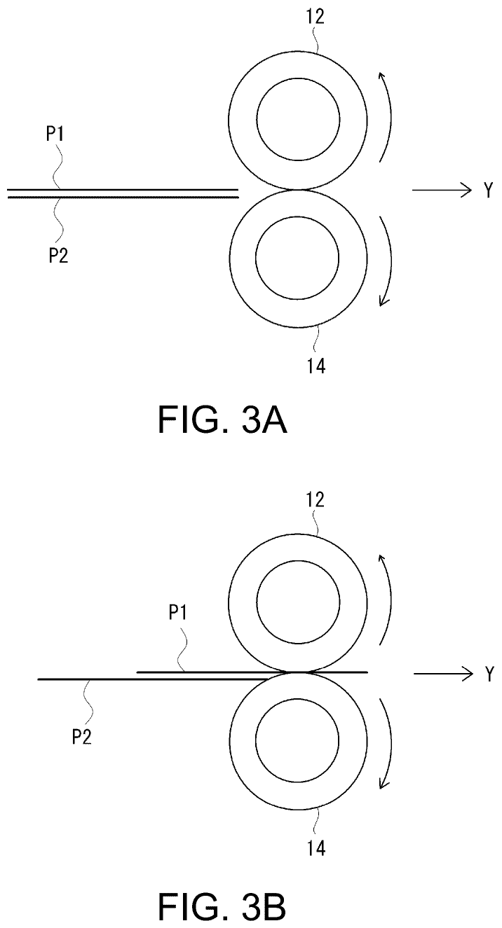

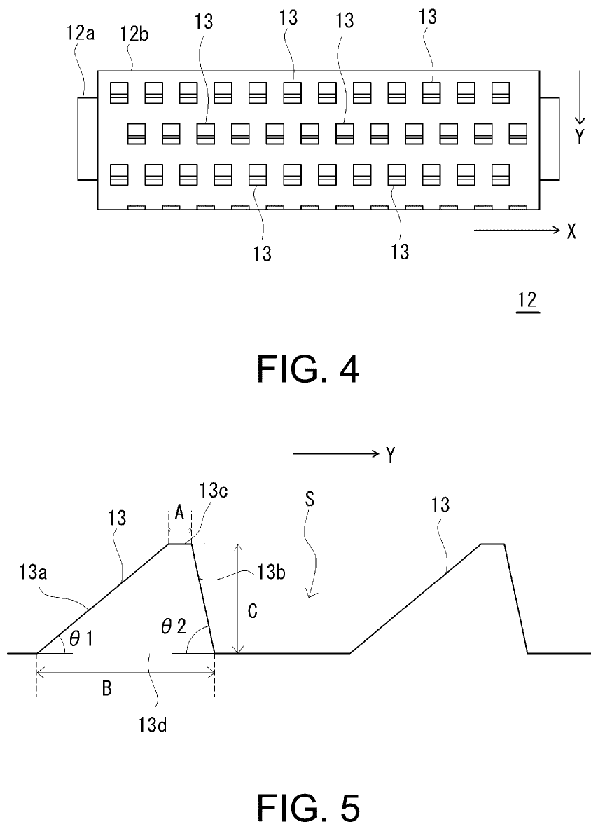

A paper feeding roll according to the disclosure will be described in detail. FIG. 1 is a schematic view of a paper feeding device. FIGS. 2A, 2B, 3A and 3B are views of a paper delivery operation of the paper feeding device shown in FIG. 1. FIG. 4 is a schematic view of the appearance of a paper feeding roll according to an embodiment of the disclosure. FIG. 5 is a schematic view illustrating the shape of a convex part.

As shown in FIG. 1, a paper feeding device 10 includes a paper delivery roll 12 (feed roll) and a separation roll 14 (retard roll). The paper delivery roll 12 has a shaft body 12a and an elastic body layer 12b formed on the outer periphery of the shaft body 12a. The separation roll 14 has a shaft body 14a and an elastic body layer 12bb formed on the outer periphery of the shaft body 14a. The paper delivery roll 12 is rotationally driven by receiving power from a drive source (motor) not shown herein and has a function of transporting a paper P. The separation roll 14 is pressed against the paper delivery roll 12 with a predetermined pressure by a biasing member (such as a spring) not shown herein. In addition, the separation roll 14 is configured with a built-in torque limiter (not shown) so that a brake torque is applied in a direction opposite to the rotation direction (the direction of the arrow sign) in which the paper P is transported.

The paper P to be transported is stacked in a paper feeding cassette 16. The surface of the drawing roll 18 (pickup roll) is in frictional contact with the upper surface of the stacked paper P, and the drawing roll 18 is configured to sequentially feed out the paper P from the paper feeding cassette 16 toward the paper delivery roll 12. The drawing roll 18 has a shaft body 18a and an clastic body layer 18b formed on the outer periphery of the shaft body 18a. The drawing roll 18 is configured to rotate in conjunction with the driving of the paper delivery roll 12 by using a connecting member (such as a gear or timing belt) not shown herein.

With the rotational driving of the paper delivery roll 12, the drawing roll 18 rotates, and the paper P is fed out one sheet at a time from the paper feeding cassette 16 toward the paper delivery roll 12. As shown in FIG. 2A, the paper delivery roll 12 is rotationally driven before the paper P arrives. The separation roll 14, which is pressed against the paper delivery roll 12, rotates passively against the brake torque due to the frictional force between the paper delivery roll 12 and the separation roll 14 (between the rolls) as the paper delivery roll 12 rotates. When a single sheet of the paper P that is fed out arrives between the rolls, as shown in FIG. 2B, the paper P passes through between the rolls and is transported in the direction of a paper passing direction Y.

When two sheets of the paper P are fed out from the paper feeding cassette 16 toward the paper delivery roll 12, as shown in FIG. 3A, before papers P1, P2 arrive, the paper delivery roll 12 is rotationally driven, and the separation roll 14 rotates passively against the brake torque as the paper delivery roll 12 rotates. When the two sheets of paper P1, P2 that are fed out arrive between the rolls, as shown in FIG. 3B, the separation roll 14 comes into contact with the paper delivery roll 12 through the two sheets of paper P1, P2. Since the frictional force working between the two sheets of paper P1, P2 is small, the separation roll 14 does not follow the rotation of the paper delivery roll 12 due to the brake torque and stops. As a result, the paper P1 in contact with the paper delivery roll 12 is transported in the direction of the paper passing direction Y through between the rolls as the paper delivery roll 12 rotates, while the paper P2 in contact with the separation roll 14 is not transported. Accordingly, duplicated feeding of the paper P is suppressed.

The paper delivery roll according to the disclosure can be suitably used as the paper delivery roll 12 (feed roll), the separation roll 14 (retard roll), and the drawing roll 18 (pickup roll), etc., in the paper feeding device 10.

The following describes the configuration of the paper feeding roll according to the disclosure, using the paper delivery roll 12 as an example. Other paper feeding rolls (separation roll, drawing roll) have a similar configuration. In the paper feeding roll shown in FIG. 4 and FIG. 5, X-direction is the axial direction, and Y-direction is the paper passing direction.

The paper delivery roll 12 according to an embodiment of the disclosure includes a shaft body 12a and an elastic body layer 12b formed on the outer peripheral surface of the shaft body 12a. The clastic body layer 12b is a layer (base layer) that forms the base of the paper delivery roll 12. The elastic body layer 12b is a layer that appears on the surface of the paper delivery roll 12.

The shaft body 12a can be a solid body, a hollow body (cylindrical body) made of metal or resin. The metal material includes iron, stainless steel, aluminum, etc. The elastic body layer 12b may be adhered to the shaft body 12a through an adhesive layer (primer layer). The adhesive, primer, etc., may be made conductive as needed.

The elastic body layer 12b is formed in a roll shape on the outer peripheral surface of the shaft body 12a by using an elastic material. The elastic body layer 12b includes multiple convex parts 13 on the outer peripheral surface. The convex part 13 has a forward inclined surface 13a whose inclination increases along the paper passing direction Y. Also, the convex part 13 has a reverse inclined surface 13b whose inclination increases in a direction opposite to the paper passing direction Y. Furthermore, at the top of the convex part 13, a top surface 13c parallel to a bottom surface 13d of the convex part 13 is provided. The top surface 13c is a surface with a smaller angle than the forward inclined surface 13a of the convex part 13. When viewed in a cross-section in the peripheral direction, the convex part 13 has a trapezoidal shape.

The convex parts 13 are each formed as an independent island in both the peripheral direction and the axial direction X of the clastic body layer 12b. The convex parts 13 are regularly arranged in a staggered pattern on the outer peripheral surface of the elastic body layer 12b. The convex parts 13 of the first row are arranged along the axial direction X of the clastic body layer 12b. Similarly, the convex parts 13 of the second row and the third row are also arranged along the axial direction X of the clastic body layer 12b. When viewed in the peripheral direction of the clastic body layer 12b, the convex parts 13 of the second row are positioned at a location offset in the axial direction from the convex parts 13 of the first row and the third row. The convex parts 13 of the first row and the third row are disposed at the same position in the axial direction. Therefore, in the peripheral direction, for example, spots S are formed between the convex parts 13 of the first row and the third row, and the spots S become portions that collect paper powder discharged from the convex parts 13.

Here, the angle θ1 of the forward inclined surface 13a is set to be 25° or more and 55° or less. If the angle θ1 of the forward inclined surface 13a is less than 25°, a shear force is less likely to be applied to the convex part 13 and the paper powder. As a result, paper powder is discharged poorly to the spot S, the friction coefficient of the roll surface after durability testing decreases, and the chance of paper jams increases. On the other hand, if the angle θ1 of the forward inclined surface 13a exceeds 55°, shear force is excessively applied to the convex part 13 to increase the amount of wear of the convex part 13, and the friction coefficient of the roll surface after durability testing decreases due to the disappearance of the inclined surface. As a result, the chance of paper jams increases. Also, because the forward inclined surface 13a of the convex part 13 is too steep, it becomes difficult to discharge paper powder to the spot S even if a shear force is applied to the convex part 13 and paper powder. From the perspective of easily discharging paper powder to the spot S, the angle θ1 of the forward inclined surface 13a is preferably 30° or more, more preferably 35° or more. On the other hand, from the perspective of easily suppressing the amount of wear of the convex part 13, the angle θ1 of the forward inclined surface 13a is preferably 50° or less, more preferably 45° or less.

The angle θ2 of the reverse inclined surface 13b is not particularly limited, but the angle θ2 may be configured to be larger than the angle θ1 of the forward inclined surface 13a. Accordingly, it is difficult for paper powder to accumulate on the top surface 13c of the convex part 13, and it is easy to discharge paper powder to the spot S. The angle θ2 of the reverse inclined surface 13b is preferably 60° or more and 90° or less. When the angle θ2 of the reverse inclined surface 13b is 60° or more, the angle θ2 of the reverse inclined surface 13b is not excessively gentle, so paper powder is easily discharged to the spot S. When the angle θ2 of the reverse inclined surface 13b is 90° or less, the strength of the convex part 13 is secured, so the shear force is easily applied to the convex part 13 and paper powder, and the paper powder is easily discharged to the spot S. From the above perspective, the angle θ2 of the reverse inclined surface 13b is more preferably 65° or more and 90° or less, and even more preferably 70° or more and 90° or less.

The angle of the top surface 13c is preferably 0° or more and 20° or less with respect to a surface parallel to the bottom surface 13d of the convex part 13. More preferably, the angle of the top surface 13c is 0° or more and 15° or less, and even more preferably 0° or more and 10° or less. By making the angle of the top surface 13c smaller than the forward inclined surface 13a of the convex part 13, the wear of the top of the convex part 13 is suppressed, and the reduction of durability is suppressed. Also, with a smaller angle of the top surface 13c, it is easier to increase the nip area. With a larger angle of the top surface 13c, the shear force is more easily applied to paper powder, making it difficult for paper powder to accumulate on the top surface 13c and easier to discharge paper powder to the spot S.

The ratio (A/B) of a peripheral length A of the top surface 13c to a peripheral length B of the bottom surface 13d of the convex part 13 is preferably 0.05 to 0.3. When the ratio is 0.05 or more, the wear of the top of the convex part 13 is more easily suppressed. Also, when the ratio is 0.3 or less, paper powder is less likely to accumulate at the top of the convex part 13, and paper powder is discharged to the spot S easily. The ratio is more preferably 0.10 or more and 0.3 or less, and even more preferably 0.10 or more and 0.25 or less.

A height C of the convex part 13 is preferably 40 μm or more and 200 μm or less. When the height C of the convex part 13 is 40 μm or more, the reduction in durability due to wear is easily suppressed. Also, a shear force is more easily applied to paper powder, making it easier to discharge paper powder to the spot S. When the height C of the convex part 13 is 200 μm or less, the strength of the convex part 13 is secured, making it easier for the shear force to be applied to the convex part 13 and easier for shear force to be applied to paper powder to easily discharge the paper powder to the spot S. Also, shear force is not excessively applied to the convex part 13, and the reduction in durability due to wear is suppressed. The height C of the convex part 13 is more preferably 50 μm or more and 150 μm or less, and even more preferably 60 μm or more and 100 μm or less.

The JIS-A hardness of the surface of the elastic body layer 12b is preferably 35° or more and 75° or less. When the hardness is 35° or more, the reduction in durability due to wear is easily suppressed. Also, when the hardness is 75° or less, the shear force is not excessively applied to the convex part 13, and the reduction in durability due to wear is suppressed. The hardness is more preferably 35° or more 70° or less, and even more preferably 40° or more and 65° or less.

In the paper feeding roll according to the disclosure, the nip area is important. The ratio of the nip area to the product of the nip width and the roll surface length at a load of 500 g is set to 0.2 or more and 0.6 or less. The nip width is the length of the nip in the peripheral direction, and the roll surface length is the roll length in the axial direction of the roll (the length of the elastic body layer 12b). By setting the ratio of the nip area to 0.2 or more, shear force is not excessively applied to the convex part 13, and the decrease in friction coefficient due to wear is suppressed. Accordingly, it is possible to suppress paper jams. Also, by setting the ratio of the nip area to 0.6 or less, a strong shear force is applied to paper powder, and the paper powder can be discharged to the spot S. This makes it possible to remove paper powder adhering to the roll surface and suppress paper jams due to a reduced friction force. The ratio of the nip area is preferably 0.25 or more and 0.55 or less, more preferably 0.3 or more and 0.5 or less. The nip area can be determined from the contact area when a glass plate is pressed against the outer peripheral surface of the elastic body layer 12a of the paper delivery roll 12 with a load of 500 gf.

The elastic body layer 12b is formed by an elastic material such as rubber, elastomer, resin, etc. The material is not particularly limited as long as it is a rubber-like elastic material. For example, conventional materials such as urethane rubber, hydrin rubber, silicone rubber, EPDM, etc., can be used.

Various additives may be appropriately added to the elastic body layer 12b as needed. Examples of the additives include lubricants, vulcanization accelerators, anti-aging agents, light stabilizers, viscosity adjusters, processing aids, flame retardants, plasticizers, fillers, dispersants, defoaming agents, pigments, release agents, etc.

The thickness of the elastic body layer 12b is not particularly limited and may be appropriately set within a range of 2 mm to 25 mm.

The elastic body layer 12b can be formed by molding using a molding die, etc. For example, a tube-shaped elastic body layer 12b can be formed by coaxially disposing a core material in the hollow portion of a roll molding die, injecting an uncrosslinked rubber composition, heating and curing (crosslinking) the composition, and then removing the product from the die. A molding die in which a concave part is formed on the inner peripheral surface of the die and which has a shape corresponding to the shape of the convex part 13 can be used. The paper feeding roll 10 can be formed by inserting the shaft body 12a into the tubularly formed elastic body layer 12b. The method for imparting a shape to the outer peripheral surface of the elastic body layer 12b is not limited to transferring by a die, but may also be a method of imparting a shape by grinding or the like.

According to the paper feeding roll 10 of the above configuration, by including the convex part 13 having the forward inclined surface 13a whose inclination increases along the paper passing direction Y on the surface of the elastic body layer 12b, the spot S for releasing paper powder can be formed. By setting the angle θ1 of the forward inclined surface 13a to 25° or more, a strong shear force is applied to the convex part 13 and paper powder, and paper powder can discharged to the spot S. Also, by setting the ratio of the nip area to the product of the nip width and the roll surface length to 0.6 or less at the load of 500 g, a strong shear force is applied to the convex part 13 and paper powder, and the paper powder can be discharged to the spot S. This makes it possible to remove paper powder adhering to the roll surface and suppress paper jams due to a reduced friction force. By setting the angle θ1 of the forward inclined surface 13a to 55° or less, shear force is not excessively applied to the convex part 13, and the decrease in friction coefficient due to wear is suppressed. In addition, by setting the ratio of the nip area to 0.2 or more, shear force is not excessively applied to the convex part 13, and the decrease in friction coefficient due to wear is suppressed. Accordingly, it is possible to suppress paper jams.

By having the top surface 13c with an angle smaller than the forward inclined surface 13a of the convex part 13 at the top of the convex part 13, the wear at the top of the convex part 13 is suppressed, and the deterioration of durability is suppressed. At this time, when the ratio (A/B) of the peripheral length A of the top surface 13c to the peripheral length B of the bottom surface 13d of the convex part 13 is 0.05 or more, the wear at the top of the convex part 13 is more easily suppressed. In addition, when the ratio is 0.3 or less, paper powder is less likely to accumulate at the top of the convex part 13, and paper powder is discharged to the spot S easily.

In addition, the convex part 13 has the reverse inclined surface 13b in which the inclination increases in a direction opposite to the paper passing direction Y. At this time, by configuring the angle θ2 of the reverse inclined surface 13b to be larger than the angle θ1 of the forward inclined surface 13a, paper powder is less likely to accumulate at the top of the convex part 13, making it easier to discharge paper powder to the spot S. In addition, when the angle θ2 of the reverse inclined surface 13b is 60° or more, the angle θ2 of the reverse inclined surface 13b is not excessively gentle, so paper powder is easily discharged to the spot S. When the angle θ2 of the reverse inclined surface 13b is 90° or less, the strength of the convex part 13 is secured. Therefore, it is possible to easily apply a shear force to the convex part 13 and paper powder, thus making it easier to discharge paper powder to the spot S.

The embodiment of the disclosure has been described above, but the disclosure is not limited to the above embodiment in any way, and various modifications are possible within the scope that does not deviate from the spirit of the disclosure.

For example, the convex part 13 in FIG. 5 has the top surface 13c with an angle smaller than the forward inclined surface 13a of the convex part 13 at the top of the convex part 13. However, in the paper feeding roll of the disclosure, it may also be that the top of the convex part does not have a top surface as shown in FIG. 5. Also, the top surface 13c of the convex part 13 in FIG. 5 is a surface parallel to the bottom surface 13d of the convex part 13, but it may also be that the top surface 13c of the convex part 13 is not parallel to the bottom surface 13d of the convex part 13.

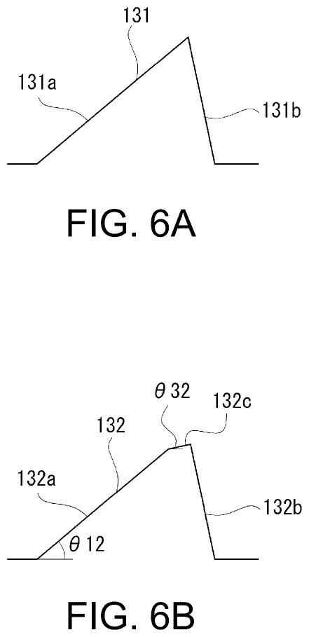

FIGS. 6A and 6B are schematic views illustrating another embodiment of the convex part.

As shown in FIG. 6A, the convex part 131 has the forward inclined surface 131a whose inclination increases along the paper passing direction Y, and the reverse inclined surface 131b whose inclination increases along the direction opposite to the paper passing direction Y. The convex part 131 does not have a top surface at the top of the convex part 131 as shown in FIG. 5. When viewed in a cross-section in the peripheral direction, the convex part 131 has a triangular shape.

As shown in FIG. 6B, a convex part 132 has a forward inclined surface 132a whose inclination increases along the paper passing direction Y, and a reverse inclined surface 132b whose inclination increases along the direction opposite to the paper passing direction Y. Also, at the top of the convex part 132, there is a top surface 132c with an angle (θ32) smaller than an angle θ12 of the forward inclined surface 132a of the convex part 132. The top surface 132c of the convex part 132 is not a surface parallel to the bottom surface of the convex part 132.

Also, the top surface 13c of the convex part 13 in FIG. 5 is a flat surface, but the top surface 13c may also be a curved surface. Also, the shape of the convex part is not limited to the shape shown in FIG. 5.

Also, multiple convex parts may also be uniformly distributed and arranged on the peripheral surface of the elastic body layer 12b, or may be randomly arranged. Moreover, the convex parts may also be arranged in an array.

### EXAMPLES

The disclosure will be described in detail below using Examples and Comparative Examples.

A tubular molding die having multiple concave parts on the inner peripheral surface was used, and an elastic body layer of a urethane rubber composition was formed on the outer periphery of a core material (φ6, made of SUS304). As a result, a paper feeding roll having multiple convex parts in a shape shown in FIGS. 4 and 5 on the outer peripheral surface of the elastic body layer was obtained. By observing the radial cross-section of the elastic body layer of the manufactured paper feeding roll, the angle θ1 of the forward inclined surface, the angle θ2 of the reverse inclined surface, the peripheral length A of the top surface, the peripheral length B of the bottom surface, and the height C of the convex part were measured. Also, the JIS-A hardness at the outer peripheral surface of the elastic body layer of the manufactured paper feeding roll was measured.

### (Nip Area Ratio)

The nip area was determined from the contact area where a glass plate was pressed against the outer peripheral surface of the elastic body layer of the paper feeding roll with a load of 500 gf. A laser microscope manufactured by Keyence was used for the measurement. Then, the ratio of the nip area to the product of the nip width and the roll surface length was calculated.

### (Friction Measurement)

The paper feeding roll was set in the friction coefficient measuring device aligned with the rotation direction, and the load was set to 2.94N (300gf) (W₁), with a pulling speed of 180 mm/s. Next, paper (Ricoh 6200 A4) was set between the paper feeding roll and a push-up plate, and the edge of the paper was connected to the load measuring device (load cell). Then, the paper feeding roll was rotated for 10 seconds or more, and the pulling force (W₂) at this time was measured. The pulling force was the average value of the stable region in the measurement chart. The friction coefficient was calculated by using the value of W₂/W₁. The friction coefficient was measured at the initial stage before testing and after the durability test with 20,000 sheets passed.

### (Durability Test)

By using the manufactured paper feeding roll, printing was repeatedly performed until a paper jam occurred, and the number of sheets passed until the paper jam occurred was measured. In addition, after 20,000 sheets of paper were passed, the friction coefficient of the outer peripheral surface of the elastic body layer and the amount of wear of the convex part (calculated from the difference in height of the convex part before and after durability testing) were also measured. The evaluation machine was “MP C2503” manufactured by Ricoh, and the evaluation was conducted in a 10° C.×10% RH environment using Ricoh My Paper A4. Cases where the number of sheets passed until a paper jam occurred was 100,000 or more were rated as “⊚”, cases where it was 50,000 or more but less than 100,000 were rated as “∘”, and cases where it was less than 50,000 were rated as “x”.

TABLE 1

| | Example | | | | | | | Comparative Example | | | |
|---|---|---|---|---|---|---|---|---|---|---|---|
| | 1 | 2 | 3 | 4 | 5 | 6 | 7 | 1 | 2 | 3 | 4 |
| Angle θ1 (°) of forward inclined surface | 40 | 55 | 25 | 40 | 40 | 40 | 40 | 15 | 70 | 40 | 40 |
| Nip area ratio | 0.35 | 0.25 | 0.5 | 0.45 | 0.4 | 0.35 | 0.6 | 0.5 | 0.35 | 0.7 | 0.1 |
| Top/bottom surface length (A/B) | 0.15 | 0.15 | 0.25 | 0.35 | 0.2 | 0.2 | 0.2 | 0.2 | 0.2 | 0.2 | 0.2 |
| Angle θ2 (°) of reverse inclined surface | [symbol] | 90 | [symbol] | 90 | 135 | [symbol] | [symbol] | [symbol] | 90 | [symbol] | 90 |
| Co [symbol] vex part height (C [symbol] μm) | 80 | 80 | [symbol] | [symbol] | 80 | 35 | 80 | 80 | [symbol] | [symbol] | 80 |
| [symbol] S-A hardness (°) | 55 | 55 | 45 | 55 | 55 | 55 | 30 | 55 | [symbol] | 40 | [symbol] |
| Friction coefficient (initial, μk) | 1.7 | 1.7 | 1.5 | 1.5 | 1.4 | 1.5 | 1.9 | 1.4 | 1.8 | 1.8 | 1.5 |
| Friction coefficient (after [symbol] durability [symbol] est, μm) | 1.5 | 1.5 | 1.3 | 1.3 | [symbol] | 1.2 | 1.2 | 0.7 | 0.9 | 0.8 | 0.8 |
| Wear of co [symbol] ex part (after [symbol] durability test, μm) | 20 | 20 | [symbol] | [symbol] | 10 | 20 | 25 | 5 | [symbol] | [symbol] | [symbol] |
| Paper jam timing (thousands of sheets) | 120 | 120 | 100 | 70 | 70 | [symbol] | 60 | 15 | 30 | 30 | 25 |
| Paper jam evaluation | ⊚ | ⊚ | ⊚ | ◯ | ◯ | ◯ | ◯ | X | X | X | X |

[symbol]

indicates data missing or illegible when filed

In Comparative Example 1, the angle θ1 of the forward inclined surface of the convex part was too small. In Comparative Example 1, the shear force was not easily applied to the convex part and paper powder, resulting in poor discharge properties of paper powder to the the spot, which caused a decrease in the friction coefficient of the roll surface after durability testing, and a paper jam was more likely to occur. In Comparative Example 2, the angle θ1 of the forward inclined surface of the convex part was too large. In Comparative Example 2, the shear force was excessively applied to the convex part, increasing the amount of wear of the convex part, reducing the friction coefficient of the roll surface after durability testing due to the disappearance of the inclined surface, and making a paper jam more likely to occur.

In Comparative Example 3, the nip area ratio was too large. In Comparative Example 3, the shear force was not easily applied to the convex part and paper powder, resulting in poor discharge properties of paper powder to the spot, which caused a decrease in the friction coefficient of the roll surface after durability testing, and a paper jam was more likely to occur. In Comparative Example 4, the nip area ratio was too small. In Comparative Example 4, the shear force was excessively applied to the convex part, increasing the amount of wear of the convex part, reducing the friction coefficient of the roll surface after durability testing due to the disappearance of the inclined surface, and making a paper jam more likely to occur.

Meanwhile, in Examples, the angle θ1 of the forward inclined surface of the convex part was 25° or more and 55° or less. Also, the nip area ratio was 0.2 or more and 0.6 or less. In the examples, with the appropriate application of shear force to the convex part and paper powder, favorable discharge properties of paper powder to the spot was attained, and the decrease in friction force and paper jams were suppressed. Also, because the shear force was not excessively applied to the convex part, the amount of wear of the convex part was suppressed, and a paper jam so caused was suppressed.

From the above, according to Examples and Comparative Examples, by having a convex part with the forward inclined surface whose inclination increases along the paper passing direction on the outer peripheral surface of the elastic body layer, the angle of the forward inclined surface being 25° or more and 55° or less and the ratio of the nip area to the product of the nip width and the roll surface length at a load of 500 g being 0.2 or more and 0.6 or less, it is possible to suppress the wear on the roll surface to ensure durability while removing paper powder adhering to the roll surface to suppress paper jams.

The embodiments and examples of the disclosure have been described above, but the disclosure is not limited to the above embodiments and examples, and various modifications are possible within the scope that does not deviate from the spirit of the disclosure.

What is claimed is:

1. A paper feeding roll, comprising: a shaft body; and an elastic body layer, formed on an outer peripheral surface of the shaft body,
wherein a convex part having a forward inclined surface whose inclination increases along a paper passing direction is provided on the outer peripheral surface of the elastic body layer,
an angle of the forward inclined surface is 25° or more and 55° or less, and
a ratio of a nip area to a product of a nip width and a roll surface length at a load of 500 g is 0.2 or more and 0.6 or less.

2. The paper feeding roll as claimed in claim 1, wherein a top surface whose angle is smaller than the forward inclined surface of the convex part is provided at a top of the convex part.

3. The paper feeding roll as claimed in claim 2, wherein a ratio of a peripheral length of the top surface to a peripheral length of a bottom surface of the convex part is 0.05 or more and 0.3 or less.

4. The paper feeding roll as claimed in claim 1, wherein the convex part has a reverse inclined surface whose inclination increases along a direction opposite to the paper passing direction, and an angle of the reverse inclined surface is configured to be greater than the angle of the forward inclined surface.

5. The paper feeding roll as claimed in claim 4, wherein the angle of the reverse inclined surface is 60° or more and 90° or less.

6. The paper feeding roll as claimed in claim 1, wherein a height of the convex part is 40 μm or more and 200 μm or less.

7. The paper feeding roll as claimed in claim 1, wherein a JIS-A hardness of a surface of the elastic body layer is 35° or more and 75° or less.
